(19) United States
(12) Patent Application Publication
(10) Pub. No.: US 2025/0122851 A1
(43) Pub. Date: Apr. 17, 2025

(54) Cycle based on compressed air by an auxiliary compressor for internal combustion engines

(71) Applicant: Abdelhakim Limane, Saint-Laurent (CA)

(72) Inventors: Abdelhakim Limane, Saint-Laurent (CA); Mustapha Limane, Reghaia (DZ)

(21) Appl. No.: 18/346,369

(22) Filed: Jul. 3, 2023

(51) Int. Cl. F02M 23/08; F02B 75/02; F02M 23/00; F02M 23/10; F02M 23/14; F02M 31/20

(52) U.S. Cl. CPC F02M 23/08; F02M 23/10; F02M 23/14; F02M 31/20; F02B 2075/025; F02M 2023/008

(57) ABSTRACT

The invention relates a process for all internal combustion engines types to control the pressure and/or the temperature inside the combustion chamber at the time of ignition of combustion, despite that the air/fuel mixture is maintained close of stoichiometry ratio. It mainly based on high compression by an auxiliary compressor of air. This air is accumulated in a reservoir. The purpose is to have two sources of compressed air with a large gape of temperature, where one source is relatively cold and corresponding to the ambient environment, and the other source is relatively hot, heated by the heat energy recovered from exhaust gases. The intake compressed air is carried out with predetermined quantity from both sources as an injection into the cylinder which contains part of the burnt gases from the previous combustion cycle, kept with predetermined quantity. This is possible because the engine operates with a two-stroke cycle.

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### BACKGROUND OF THE INVENTION

Not Applicable

### BRIEF SUMMARY OF THE INVENTION

The present invention relates a process for all internal combustion engine types in order to improve the energy efficiency and to reduce the polluting emissions. This process regulates regardless of the load, the pressure or the temperature, or both pressure and temperature inside the combustion chamber when the combustion is engaged.

During these last times several innovations have been carried out to improve the energy efficiency and to reduce the polluting emissions of the internal combustion engines. These includes the downsizing with turbocharger, the recirculation of the burnt exhaust gases (EGR) and the adoption of the direct injection that allow cooling the admitted air, creating a stratified mixture and control the oxygen level specially at low-load. However, it should be noted that on the one hand, these solutions cannot meet the environmental standards requirements. The engines manufacturers have had to equip with more large particulate filters and chemical catalysts causing the loss of efficiency and increasing the weight. On the other hand, the operation at low revolution per minute (RPM) and low load have been favored over that at high RPM and full load, in addition to the unreliability issue resulting there from.

### BRIEF DESCRIPTION OF THE SEVERAL VIEWS OF THE DRAWINGS

The figures illustrated are theoretical simplified and devoid of the organs such as the various sensors or silencer.

FIG. 1 represents the circuit that the air follows from its suction (1) to its exhaust (11) for an internal combustion engine with direct fuel injection as diesel engine.

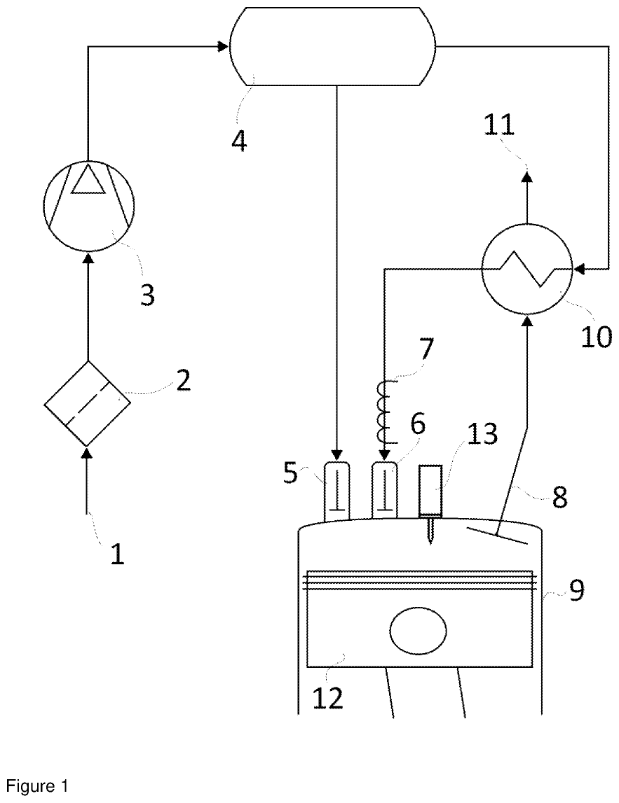

FIG. 2 represents the circuit that the air follows from its suction (1) to its exhaust (11) for an internal combustion engine as petrol engine with indirect fuel injection at upstream of the micro-valve (14).

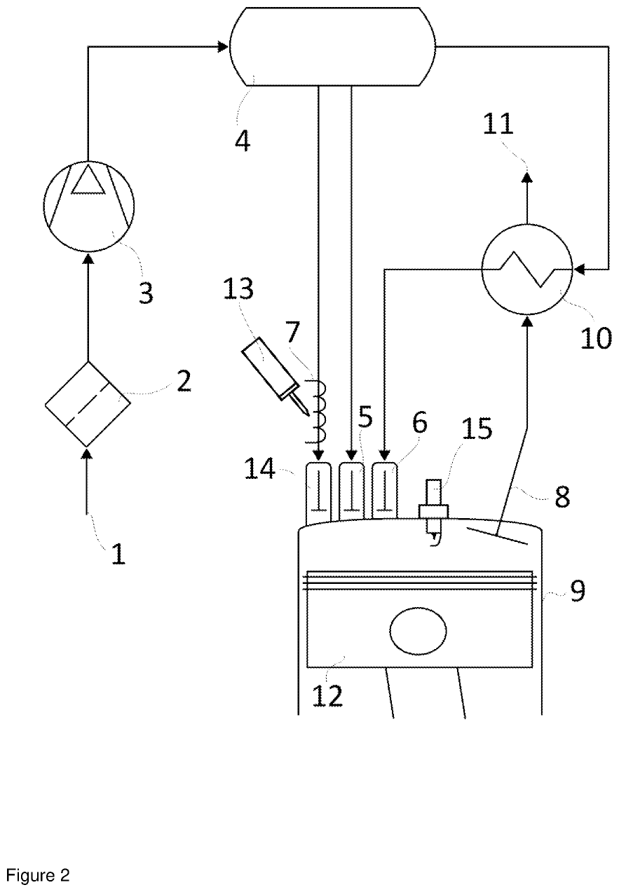

### DETAILED DESCRIPTION OF THE INVENTION

The present invention is based on the following six steps:
Compressing highly the air by an auxiliary compressor.
Accumulating a compressed air at a relatively cold temperature in the reservoir.
Operating the internal combustion engine with a two-stroke cycle.
Keeping in the cylinder a part of the hot burnt gases of the preceding combustion cycle in order to operate it in the current combustion cycle.
Having an intake valves extremely small and lightweight as compressed air injectors controlled individually by the engine control unit (ECU).
Having a heat exchanger to heat the compressed air by the burnt exhaust gases.

This process is mainly based on the high compression of the air by an auxiliary compressor (3), driven by the internal combustion engine. As a result, once the air is sucked (1) and filtered by the air filter (2), its compression is partly carried out by the auxiliary compressor (3) and not by the piston (12) of the internal combustion engine. Therefore, the energy necessary to make this compression will be minimized, because it can be carried out in a well-cooled manner. This compressed air is accumulated in a reservoir (4) at relatively cold temperatures (ambient environment) which will be used in several operations such as combustion oxidizer, heat transfer fluid to recover part of the heat energy of the burnt exhaust gases before releasing them (11) and to actuate pneumatic systems of the engine. On the other hand, this reservoir of compressed air provides several advantages:
Recovering a part of the kinetic energy of vehicle in the form of compressed air by using the auxiliary compressor as a brake.
Recovering the mechanical energy of the internal combustion engine when is idling or without an external load in the form of compressed air.
Using a compressor or compressors as a variable additional load for the internal combustion engine to help the internal combustion engine to operate at its desired operating point.
Actuating the internal combustion engine as a pneumatic motor.
Vanishing of the turbo lag, if the engine is equipped with a turbocharger, since it does not directly interfere with the engine.
Less risk to burn the oil vapors, since the gases in the crankcase pass firstly through the auxiliary compressor (3) and the reservoir (4).
Possibility to obtain additional power by disconnecting the auxiliary compressor (3) from the engine.

This process operates an internal combustion engine with a two-stroke cycle. During the downward stroke of the piston (12), the engine produces the power by the expansion of the gases in the cylinder.

However, the fact that this engine operates with a two-stroke cycle, the weight, the size and the friction are divided by two compared to the engine operating with a four-stroke cycle. On the other hand, the exhaust camshaft can be used to balance the engine since it has the same speed as the crankshaft.

This process makes the exhaust of only parts of the burnt gases, when the piston (12) is close to the bottom dead center. The parts of the burnt gases exhausted are evacuated either by the exhaust valve (8) or by an exhaust port located at the bottom of the engine block (9). The duration of the exhaust operations correspond with relatively small angle executed by the crankshaft, especially for a diesel type engine. As a result, some of the hot burnt gases of the preceding combustion cycle remain kept into the cylinder in order to operate it in the current combustion cycle. Furthermore, since compressed air is available, the opening and closing of the exhaust valve (8) can be done at extremely fast without a spring.

The intake of compressed air which serves as an oxidizer is carried out by micro-valves (5, 6, 14) which are small, light and with very small displacement stroke, since they intake an extremely dense air. These micro-valves (5, 6 and 14) are assimilated to oxidizer injectors in the cylinder. The availability of the compressed air can be easily controlled individually these micro-valves (5, 6 and 14) by the engine control unit (ECU).

The intake micro-valves (5, 6 and 14) are to ensure a maximal pressure drop when they are closed in order to limit the leakage as much as possible. In order to preserve the pressure in the reservoir (4), the sealing is ensured by other valves fitted with gaskets to seal. These other valves are actuated as soon as the engine is stopped.

The air intake operation manifests as an injection of oxidizer into the cylinder with a large turbulent intensity. It is carried out at same time with the exhaust or compression or both exhaust and compression operations. When it is carried out in parallel with the exhaust, it is to regulate and adjust the quantity of the burnt gases of the preceding combustion cycle to be kept for the current cycle. As the air admitted into the cylinder comes from a confined place which is the reservoir (4) of compressed air, the temperature and pressure can be known with high accuracy. As the result, the quantity of air admitted into the cylinder can be controlled with great accuracy also. On the other hand, due to the pressure difference between the upstream and downstream of the micro-valves (5, 6 and 14), the intake air is manifested as a jet in the cylinder with high turbulent intensity and a very large mixing section (increase in the recirculation of the gases inside the cylinder). Therefore the air/fuel mixture is more homogenous during the combustion. Consequently, the appearance of the soot and the unburned fuel after combustion decreases.

In order to regulate the temperature and/or the pressure at the moment when the combustion is engaged, the intake air is done by at least two micro-valves (5, 6, and 14):
The micro-valves (5, 14) introduce the relatively cold air coming directly from the reservoir (4).
The micro-valve (6) introduces the relatively hot air, by passing it through a heat exchanger (10) which recovers some of the heat from the exhaust gases.

The ECU predetermines the opening time of each micro-valve, in order to adjust the predefined quantities to be admitted. The quantity of the hot burnt gases that kept in the cylinder depends on the quantity of the compressed air admitted into the cylinder by the micro-valves (5, 6 and 14), when the exhaust valve (8) is still open. This compressed air will expel the burnt hot gases from the cylinder and exhausts it according to the quantity of the compressed air admitted. Once the intake is complete, the rest of the upward stroke of the piston (12) is dedicated only to the compression of the air or of the air/fuel mixture until it is confined in the combustion chamber.

Due to the configuration of the two-stroke cycle engine and the intake air is as like the oxidizer injection into the cylinder, the engine will be able to operate with an Atkinson cycle without pumping effect, since the quantities of air and fuel admitted are completely under control. This improves significantly the energy efficiency of the engine.

The final mixture inside the cylinder at the combustion is composed by all quantities of compressed air and/or compressed air/fuel mixture injected into the cylinder by the different micro-valves (5, 6 and 14) and the quantity of the burnt gases kept in the cylinder. The temperature and/or the pressure of the final mixture inside the cylinder are controlled when the combustion is engaged despite respecting proportions fuel/oxidizer close to the stoichiometry ratio, because the ECU adjusts the different predefined quantities of compressed air injected into the cylinder by the different micro-valves (5, 6 and 14), and the quantity of the burnt gases kept in the cylinder. Those different predefined quantities depend to: the data coming from the various sensors, the load, the RPM, the different temperatures and pressures of compressed air admitted and the temperature of the burnt gases kept in the cylinder which is deduced from the quantity of fuel injected from the preceding combustion cycle.

In the case of a diesel type engine, this process ensures regardless of the load the set point temperature which guarantees the auto-ignition despite respecting proportions of fuel/oxidizer close to the stoichiometry ratio. This is accomplished by non-exhausted hot gases kept in the cylinder and the intake air admitted with a predetermined quantity which is heated by passing it through a heat exchanger (10) in advance or by electric heating (7) while there is not enough heat to be recovered as in the case of cold start. The heating that should come from the compression will be minimized and compensated by the heat recovered from the exhaust gases and that of the burnt hot gases of the preceding cycle kept in the cylinder. This process provides the stabilization of the auto-ignition conditions at the injection of the fuel (13) despite respecting the proportions air/fuel close to the stoichiometry ratio regardless of the load.

In the case where the engine use the spark plug for ignition, this process allows to have a set point pressure at the moment of ignition by the spark plug (15) despite respecting proportions fuel/oxidizer close to the stoichiometry ratio regardless the load. To avoid engine knock, more the load increases more the set pressure must decrease. In other words, more the load increases more the quantity of hot burnt gases to exhaust must be increase, and/or the compressed air must be more injected with the relatively cold temperature by the micro-valve (5) than with the relatively hot temperature by the micro-valve (6). As a result, the pressure at the time of ignition can be controlled and the engine behaves like a variable compression ratio engine.

The indirect injection of the fuel by the injector (13) is desired because it provides more time for the fuel to volatilize and evaporate. A second micro-valve (14) is added of relatively cold compressed air provided directly from the reservoir (4). The fuel is injected at its upstream of the micro-valve (14). The heating (7) serves to supply just the necessary heating to promote the evaporation of the fuel. This heating (7) is electrical at cold but can be supplied by the engine oil or the cooling liquid, once the engine is hot enough. The air/fuel mixture that forms at upstream of this micro-valve (14) must be rich so that the final mixture in the cylinder by adding all the quantities of air admitted by the intake micro-valves (5, 6 and 14) at the time of ignition is close to the stoichiometry ratio. However, the intake of the air/fuel mixture by the micro-valve (14) is done once the temperature of the gases inside the cylinder is regulated by the intake of compressed air by the other micro-valves (5, 6) in order to avoid the auto-ignition of the mixture.

Since this process provides a control of the temperature and the pressure into the cylinder at the ignition of the combustion, it can allow the engine to operate as homogeneous-charge compression-ignition engine (HCCI). This process allows achieving the conditions of auto-ignition at less lean and closer to stoichiometry proportions, regardless of the load.

Finally, this process can be operates the engine whether it is diesel, with spark plug or HCCI by alternating between a cycle with a combustion and a cycle without a combustion as a pneumatic motor using the compressed air to actuate it. This compressed air is previously heated by the exchanger (10) to recover the heat energy of the exhaust gases. Therefore, the efficiency of the engine will be optimized by to convert the maximum heat energy generated by the combustion into mechanical power and also to reduce the cooling requirements of the engine.

In summary, the present invention improves the overall energy efficiency of the engine and limits the polluting emissions produced such as soot, carbon monoxide CO, carbon dioxide CO2 and nitrogen oxides NOx, due to the following characteristics for any type of an internal combustion engines:
Converting a maximum of the heat energy of combustion into mechanical energy.
Generating the more optimal pressure and/or temperature for combustion regardless of the load.
Respecting to the proportions close to the stoichiometry ratio regardless the load.
Optimizing the mixture inside the cylinder by increasing the turbulent intensity and the circulation of the gases.
Eliminating the losses due to the pumping during the intake spatially at low load.
Saving part of the energy required to the compression.
Recovering the energy of the engine when is idling without an external load in the form of compressed air.
Recovering part of the heat energy of the exhaust gases.
Recovering part of the kinetic energy during braking in the form of compressed air.
Reducing losses due to friction between the mechanical parts (two-stroke cycle engine).
Decreasing the overall weight of the engine (two-stroke cycle engine).
Decreasing the size of the engine (two-stroke cycle engine).

1. A process for any type internal combustion engine said cycle based on compressed-air. The said cycle based on compressed-air is characterized in that it uses a two-stroke cycle internal combustion engine, where the air to be intake said compressed-air is pre-compressed by at least one compressor. The operation of intake is done at the same time with the exhaust or compression operations, or both exhaust and compression for the combustion cycle. The intake operation is the injection of the said compressed-air and/or the said compressed-air/fuel mixture into the cylinder or the chamber containing the gases of the internal combustion engine. This injection carries out by at least one injector said micro-valve of the said compressed-air or the said compressed-air/fuel mixture. The said cycle based on compressed-air adjusts the quantity or the quantities depending to their temperatures of the said compressed-air and/or the said compressed-air/fuel mixture to inject and adjusts the quantity of the burnt gases to keep in the cylinder or the chamber containing the gases of the internal combustion engine. The injection of the said compressed-air and/or the compressed-air/fuel mixture can be done with quantities where theirs temperatures are different. The relatively cold quantity of the said compressed-air and/or the compressed-air/fuel mixture is due to the preliminary its passage by at least one heat exchanger for cooling it, or coming from the compressed-air reservoir, or from the compressor which compresses it. The relatively hot quantity of the said compressed-air and/or the compressed-air/fuel mixture is due to the preliminary its passage at least one heat exchanger recovering the heat energy of the internal combustion engine such as the heat of the exhaust gases or of its accessories, or by electrical heating, or coming from the compressed-air reservoir or from the compressor which compresses it. The quantity of the burnt gases to keep in the cylinder or the chamber containing the gases of the internal combustion engine is adjusted by the injection with adjusted quantity or quantities of the said compressed-air and/or the compressed-air/fuel mixture by at least the said micro-valve, when the exhaust-valve or the exhaust-port is open.

2. According to claim 1, said cycle based on compressed-air is characterized in that it has the possibility of using a compressor or compressors by which the said compressed-air is compressed: to recover a part of energy in the form of compressed air when the vehicle brakes and/or when the internal combustion engine is idling or is without an external load, and as a variable additional load for the internal combustion engine.

3. According to claim 1, said cycle based on compressed-air is characterized in that during the expansion of the gases in the cylinder or the chamber that contains the gases, an injection of the said compressed-air and/or the compressed-air/fuel mixture can be carried out.

4. According to claim 1, said cycle based on compressed-air is characterized in that it has the possibility of using a said compressed-air to actuate the internal combustion engine as a pneumatic motor, and/or the pneumatic systems of the internal combustion engine, and/or the pneumatic systems of the vehicle. The internal combustion engine has the possibility to work by alternating between a cycle or cycles with combustion, and a cycle or cycles without combustion as a pneumatic motor.
